(19) United States
(12) Patent Application Publication
(10) Pub. No.: US 2022/0318773 A1
(43) Pub. Date: Oct. 6, 2022

(54) SYSTEM AND METHOD FOR A PAYMENT CARD-BASED EXECUTION OF A MULTIPARTY TRANSACTION INVOLVING ELECTRONIC FUNDS DISBURSEMENT

(71) Applicant: Rent-A-Center West, Inc., Plano, TX (US)

(72) Inventor: Jason Jude Hogg, Boca Raton, FL (US)

(73) Assignee: Rent-A-Center West, Inc., Plano, TX (US)

(21) Appl. No.: 17/714,597

(22) Filed: Apr. 6, 2022

Related U.S. Application Data
(60) Provisional application No. 63/171,294, filed on Apr. 6, 2021.

(51) Int. Cl. G06Q 20/12; G06Q 30/06; G06Q 20/40

(52) U.S. Cl. CPC G06Q 20/127; G06Q 30/0645; G06Q 20/40

(57) ABSTRACT

In an illustrative embodiment, systems and methods by which a mobile device accessible by a consumer may be used to cooperate with a remote computing platform operated by a lease-to-own or subscription company to initiate a payment for an item that is the subject of a lease-to-own or subscription arrangement between the consumer and the lease-to-own or subscription company. The mobile device executes an app that permits the user to acquire information about the item, including information identifying the item, and according to some embodiments, a price of the item. The mobile device and the remote computing platform cooperate to form an agreement concerning an arrangement concerning the item. The mobile device stores a payment card in an onboard secure element. The remote platform defines criteria permitting an authorization request pertaining to the payment card as used to pay for the item in connection with the arrangement to be approved.

### CROSS-REFERENCE TO RELATED APPLICATIONS

This application claims the benefit of U.S. Provisional Application No. 63/171,294, filed Apr. 6, 2021, and titled “SYSTEM AND METHOD FOR A PAYMENT CARD-BASED EXECUTION OF A MULTIPARTY TRANSACTION INVOLVING ELECTRONIC FUNDS DISBURSEMENT,” the disclosure of which is hereby incorporated herein by reference.

### TECHNICAL FIELD

Herein is disclosed a system and method for improved execution of a funds disbursement scenario involving plural parties, and more particularly to a payment card-based system and method by which a consumer may initiate a payment to a retailer in consideration of an item that is the subject of an arrangement between a lease-to-own or subscription company or the like and the consumer.

### BACKGROUND

Certain varieties of transactions involve funds disbursement scenarios involving plural parties, and require that certain constraints be imposed upon some of the parties, either for the purpose of preserving the integrity of the transaction or for the purpose of security. For example, a lease-to-own transaction may involve three parties: a retailer that offers goods for sale to the general public, a customer seeking to acquire goods from the retailer typically for household or personal use, and a lease-to-own company that, as a service to the retailer, offers a program to purchase goods from the retailer to provide them to consumers through a lease-to-own transaction. In such a scenario, where the customer is unable or unwilling to utilize cash or a consumer credit sale to acquire goods, the lease-to-own company will purchase, from the retailer, those goods identified by the customer and enter into a lease-to-own agreement with the customer for those goods.

To safeguard the integrity of the transaction, the lease-to-own company imposes certain constraints. The lease-to-own company will not enter into a lease-to-own arrangement in connection with a product that is consumable, disposable or otherwise not amenable to the potential of return by the customer to terminate the lease-to-own transaction. Thus, for example, flooring would not be the proper subject of a lease-to-own arrangement, because by its nature it is permanently installed and cannot be readily returned. A lease-to-own company may involve its personnel in the initiation of a lease-to-own arrangement to ensure that the leased product is of a proper nature. Alternatively, the lease-to-own company may establish a relationship with the retailer in advance of extending any such lease-to-own arrangements to ensure that the retailer will not offer its products to consumers on a lease-to-own basis, if they are not of a suitable variety.

To protect itself from the possibility of fraud, the lease-to-own company typically selects a funds disbursement mechanism in which the lease-to-own company remains in control of the initiation of the payment of the retailer. A lease-to-own company would not, for example, provide its customers with a payment tool by which the consumer could initiate the payment, because such a tool would expose the company to fraud. Instead, the lease-to-own company may aggregate the sums owed to a given retailer in consideration of all of the transactions leased via its lease-to-own arrangements during a given month, and then initiate a lump-sum wire transaction to the retailer at the end of the month. This creates a difficulty on the part of the retailer related to reconciling the payment with the proper underlying sales transactions as recorded in the retailer's internal records.

The necessity of protecting the integrity of a lease-to-own transaction combined with the additional necessity of suppressing fraud in connection with its concomitant funds disbursement results in inefficiencies: relationships between the lease-to-own company and a retailer must be formed in advance, reconciliation of payments with underlying transactions is difficult and prone to error, and personal involvement of the personnel of the lease-to-own company may be required. These outcomes are inimical to the goal of efficient and proper functioning of a multiparty transaction involving funds disbursement.

### SUMMARY

Against this background, the present subject matter was developed. According to some embodiments a system for permitting a consumer to initiate payment to a retailer in consideration of an item marketed for sale by the retailer, wherein the item is a subject of a lease-to-own arrangement between the consumer and a lease-to-own company, includes a mobile computing device. The mobile computing device is accessible by the consumer, and the mobile computing device includes a processing unit and a memory communicably connected with and readable by the processing unit. The memory unit contains instructions that, when executed by the processing unit, cause the processing unit to acquire information concerning the item, and communicate said information to a remote computing platform operated by the lease-to-own company for evaluation of suitability for inclusion in a lease-to-own arrangement. Additionally, the processing unit cooperates with the remote computing platform to create an agreement forming said lease to own-arrangement between the consumer and the lease-to-own company. The consumer is permitted to initiate payment for the item at the retailer via a payment card stored on a secure element onboard the mobile computing device. The payment card is associated with an account, the activity of which is handled by an issuer processor computing platform that is responsive to communication from the remote computing platform in order to determine authorization criteria for authorization requests pertaining to the payment card.

### BRIEF DESCRIPTION OF THE DRAWINGS

FIG. 1 depicts certain embodiments of a system that operates to permit a consumer to initiate a payment on behalf of a lease-to-own or subscription company to a merchant.

FIGS. 2A-2B depicts certain embodiments of a method executed by the system depicted in FIG. 1.

FIG. 3 depicts certain embodiments of a system that operates to permit a consumer to initiate a payment on behalf of a lease-to-own or subscription company to a merchant.

FIGS. 4A-4E depict certain embodiments of a method executed by the system depicted in FIG. 3.

FIG. 5 depicts certain embodiments of a method for termination of a lease-to-own or subscription arrangement or the like, which may be executed by the systems of FIG. 1 or FIG. 3, for example.

FIG. 6 depicts certain embodiments of a server, computing platform, computer, tablet, smartphone or mobile device.

### DETAILED DESCRIPTION

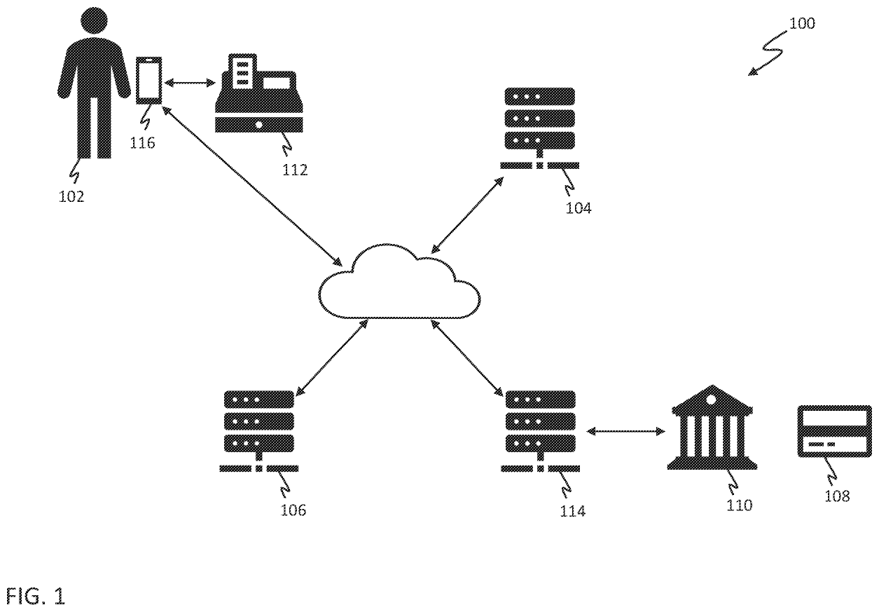

FIG. 1 depicts an embodiment of a system for disbursement of funds in connection with a multiparty transaction. Notably, the system of FIG. 1 permits the funds disbursement to be initiated via a payment card (including via a virtual payment card). Herein, various methods, apparatuses and systems are presented, and are discussed with reference to a lease-to-own company that offers lease-to-own arrangements to consumers. A lease-to-own arrangement is but one example of a multiparty transaction in which the methods, apparatuses and systems disclosed herein are useful, and the inventions disclosed herein are not limited to use solely in connection therewith. The methods, apparatuses and systems disclosed herein are useful in connection with a subscription arrangement, in which a consumer subscribes to a product and pays a periodic (example: biweekly or monthly) fee in exchange for the right to possess and use the product during the course of the subscription period. Moreover, the methods, apparatuses and systems disclosed herein are useful in connection with any form of financing arrangement, including but not limited to consumer financing arrangements, such as retail installment sales, revolving credit lines, open-ended accounts, and any form of secured or unsecured credit. Although references are made herein to a lease-to-own company or subscription company, such reference is made for the sake of illustration only and imply no limitation regarding the fields of use of the systems, methods and apparatuses disclosed herein. Moreover, although the particular transactional constraint referenced herein relates to suitability of a good for conveyance via a lease-to-own or subscription arrangement, the methods, apparatuses and systems disclosed herein are not so limited and may be adapted to apply to another such transactional constraint.

FIG. 1 depicts a system 100 that operates to permit a consumer 102 to initiate a payment on behalf of a lease-to-own or subscription company to a merchant. The lease-to-own or subscription company operates a backend computing platform 104 that performs, among other operations, the informational operations constituting the lease-to-own or subscription business. For example, the platform 104 may execute processes or services by which: (i) a consumer 102 may apply for approval for enrollment in such lease-to-own or subscription arrangements with such company; (ii) information in addition to that supplied by the consumer 102 during the application process may be acquired (such as via interacting with one or more supporting services 106 operated by third-parties); (iii) the consumer 102 may be evaluated on the basis of his or her application information and any additional information acquired by the platform 104, resulting in decisions pertaining to whether the consumer 102 is qualified to be a customer of the company, and, if so, the appropriate size of an open-to-lease or open-to-subscribe line to be assigned to such consumer 102; (iv) proposed products or services are evaluated for suitability for extension of such lease-to-own or subscription arrangements; and (v) contracts can be constructed and executed in order to establish the contractual infrastructure of such lease-to-own or subscription arrangements. The backend computing platform 104 performs other operations described herein, below.

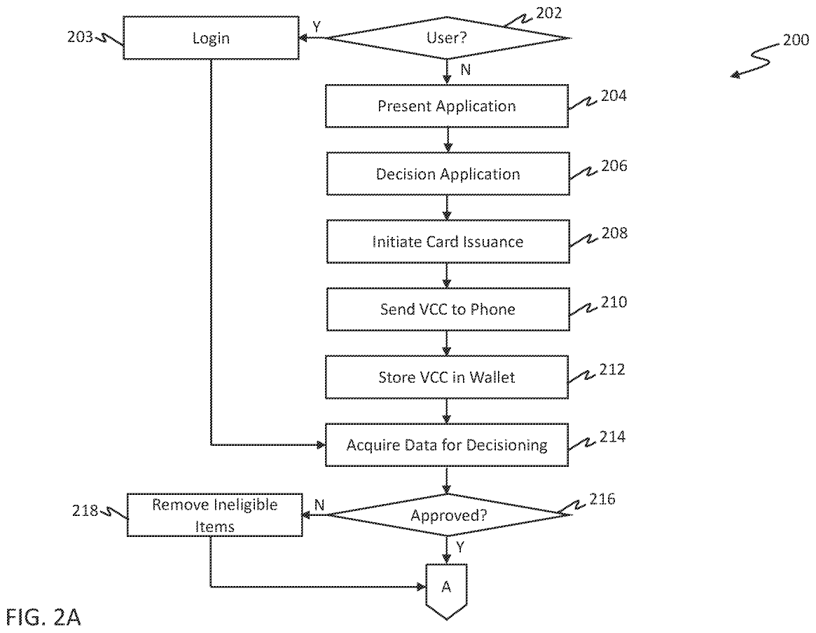

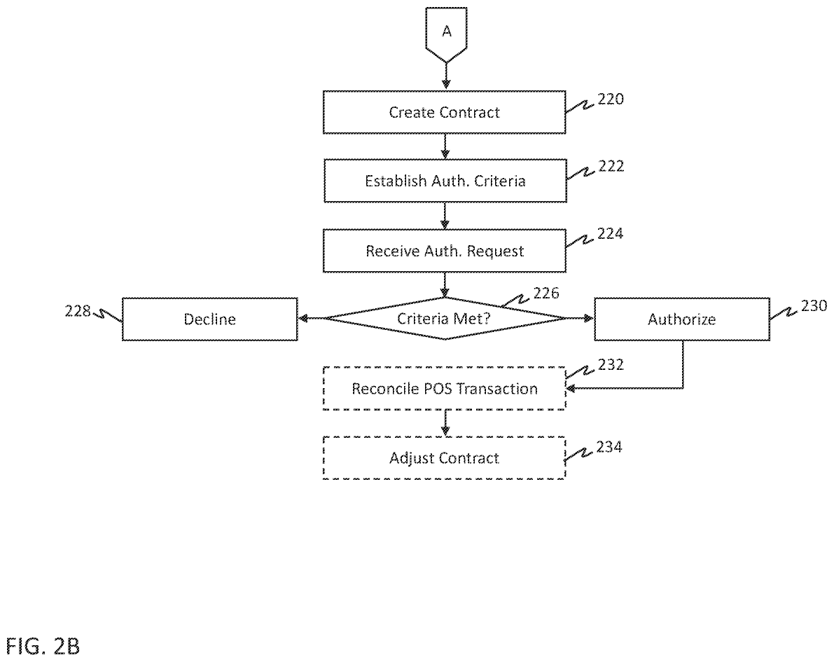

The consumer 102 initiates payment on behalf of the lease-to-own or subscription company via a payment card 108 at a point of sale device 112 of a retailer. The payment card 108 may be embodied as a physical payment card or as a virtual payment card. According to some embodiments, the payment card 108 is issued by an issuer 110, such as a bank. The issuer 110 may be a member of a major payment network (example: payment networks such as Mastercard®, Visa®, etc.). The issuer 110 may engage an issuer processor to process payment transactions originating from such payment cards 108. The issuer processor operates a processing platform 114 that performs such processing functions (example: receives authorizations requests pertaining to payment cards 108, responds to such authorization requests, functions as a system of record for the account or accounts corresponding to such payment cards 108, and so on). The consumer 102 may interact with the system 100 via a mobile device 116, such as a smartphone, tablet, laptop, and so on. The mobile device 116 may execute an application (“app”) published by or on behalf of the lease-to-own or subscription company. Together, all of the elements 102-116 of the system 100 cooperate to perform the operations of FIGS. 2A and 2B.

FIGS. 2A and 2B depict a method 200 by which a consumer 102 may interact with the system 100 of FIG. 1 to initiate a lease-to-own or subscription arrangement vis-à-vis a product or service offered for sale by a particular retailer. Together, the system 100 and method 200 operate so as to permit such arrangements to be effected without the necessity of involvement of personnel from the lease-to-own or subscription company at the retailer's premises. Moreover, the system 100 and method 200 operate so as to permit the possibility that such lease-to-own or subscription arrangements may be made available with respect to goods or services offered for sale by retailers with which the lease-to-own or subscription company has no previous course of dealing (meaning, among other things, that it may be the case that the company has not participated in a systems integration effort with the retailer). While it is the case that the system 100 and method 200 create the possibility that the retailer and lease-to-own or subscription company may have no prior course of dealing and may not have integrated their respective computing platforms, this is not a requirement. According to some embodiments, the retailer and lease-to-own or subscription company have, in fact, integrated their computing platforms.

The operations of the method 200 of FIGS. 2A and 2B involving interaction with the consumer 102 are described herein as being performed by an app that is published by or on behalf of the company and is executing on the consumer's 102 mobile device 116. This is for the sake of ease of narrative description only—these operations may be performed via a website accessed by the consumer 102, such as via a web browser executing on his or her mobile device 116 (or on another computing device).

The narrative backdrop of the use case of the method 200 and system 100 is that a consumer 102 is at a retailer's brick-and-mortar retail location, and desirous of acquiring a good or service via either a lease-to-own arrangement or a subscription arrangement. This is for the sake of narrative ease. The method 200 and system 100 may be used in connection with other scenarios, such as a purchase conducted via an online retailer (an e-retailer).

Turning now to the scenario in which a consumer 102 is located at a retailer's brick-and-mortar retail location, and desirous of acquiring a good or service via either a lease-to-own arrangement or a subscription arrangement, the user begins by accessing his or her mobile device and launching the aforementioned app. In operation 202, it is determined whether or not the consumer 102 is a pre-existing user or of the system 100. For example, the app may present the user with a user interface screen that prompts him or her to either enter login credentials or indicate that he or she is a new user.

In the event that the consumer 102 is not a pre-existing user of the system 100, control is passed to operation 204. In operation 204, the user is presented with an application by which he or she may enter information identifying himself or herself and any other information required by the system for evaluating whether or not to permit the consumer 102 to enter into lease-to-own or subscription arrangements with the company, and, in the event of a positive determination, the size of an appropriate lease-to-own line or open-to-subscribe line to extend to the consumer 102. For example, the aforementioned app may present the user with one or more user interface screens prompting the consumer 102 to enter such information.

In operation 206, the information either directly obtained from the consumer 102 via application operation 204 or obtained indirectly by use of such information is evaluated. According to some embodiments, one or more third-party systems 106 that supply supporting services (example: identity verification services, employment verification services, background check services, and so on) are accessed with the information supplied by the user in operation 204, and the services supply additional information concerning the consumer. The output of the evaluation may be two-fold: (1) a decision of whether or not to permit the consumer 102 to enter into lease-to-own or subscription arrangements with the company; and (2) in the event that aforementioned decision is affirmative, a determination of an appropriate size of an open-to-lease line or open-to-subscribe line to assign to such consumer 102. According to some embodiments, an open-to-lease line is a value that defines the maximum amount of paid-out currency (example: dollars, euros, pesos, etc.) that the lease-to-own company is willing to spend to acquire goods or services that are the subject of active leases to the consumer 102. According to some embodiments, an open-to-subscribe line is a value that defines the maximum amount of paid-out currency (example: dollars) that the subscription company is willing to spend to acquire goods or services that are the subject of active subscriptions between the consumer 102 and the company. According to some embodiments, operations 204 and 206 are performed by processes or services executing on the backend computing platform 104.

Next, in operation 208, issuance of a payment card 108 to the consumer 102 is initiated. According to some embodiments, the payment card 108 accesses a master account maintained at the issuer 110 and titled in the name of the lease-to-own or subscription company. Thus, according to such embodiments, the accountholder of the master account is the lease-to-own company or subscription company, and it is the responsibility of the company to fund the master account with sufficient sums so that the master account may serve as the source of funds to purchase goods or services that are the subject of lease-to-own or subscription arrangements. For example, the company may employ a just-in-time account funding strategy wherein it sources the aforementioned master account with sums as they are required, such as with the occurrence of each card 108 transaction to be funded (example: the company may establish a depository account with the issuer 110 and fund it with a sum of cash expected to be equal to the aggregate of all card 108 transactions to be funded over a chosen number of days, such as seven days; with the occurrence of each card 108 transaction, funds may be transferred from the depository account to the aforementioned master account). Each consumer 102 that is approved as a customer of the company in operation 206 is added to the master account as an authorized user, and is issued a payment card 108 with a card number that is unique. Thus, any given card number is uniquely associated with a particular consumer 102 that is a customer of the lease-to-own or subscription company. Thus, the consumer 102 is authorized to use the payment card 108 issued to him or her to draw funds from the master account in order to fund purchases of goods or services that are the subject of lease-to-own or subscription arrangements between the consumer 102 and the company. According to other embodiments, the payment card 108 may be associated with a credit account titled in the name of the lease-to-own or subscription company (with each approved consumer 102 being added to such account as an authorized user and issued a payment card 108 with a unique card number). According to such embodiments, as consumers 102 initiate transactions via the cards 108, the issuer 110 extends credit to the company, and a corresponding debt to the issuer 110 is incurred by the company. It is the responsibility of the company to pay the aforementioned debt to the issuer 110. The payment cards 108 may be embodied as physical payment cards or virtual payment cards. According to some embodiments, in operation 208, the consumer 102 is issued both a virtual payment card and a physical payment card, with the virtual payment card being usable a limited number of times, such as being usable but a single time. The physical payment card 108 and virtual payment card 108, while both associated with the same consumer 102, may have different card numbers so that they may be distinguished from one another. The virtual payment card 108 is sent immediately to the mobile device (operation 210), while the physical card 108 is sent to the consumer 102 via postal service or courier service. The virtual payment card 108 is thus available for use by the consumer 102 immediately, and may be used to acquire the desired items from the retailer via a lease-to-own or subscription arrangement. The physical payment card 108 will become available for such use upon its physical delivery to the consumer (example: after a one-or-two-day delivery period). According to some embodiments, operation 208 is performed via a communication exchange between the backend computing platform 104 and the processor platform 114.

In operation 212, the virtual payment card 108 is processed by a wallet app executing on the mobile device 116. The wallet app may initiate a process to tokenize the virtual payment card, and store the token as a proxy for its card number in a secure element on the mobile device 116. For example, according to some embodiments, a secure element is integrated into a near-field chip (NFC) aboard the mobile device 116, and a token corresponding to the virtual payment card 108 is stored therein. (A token is a value distinct from, but associated with, the card number of the virtual payment card 108. During the course of a payment transaction, the token—bundled inside of an authorization request—is ultimately received by the aforementioned payment network on which the virtual payment card 108 is operable. The payment network replaces the token value with the card number. The payment network then routes the authorization request to the processor 114, which ultimately approves or declines the authorization request). The aforementioned wallet app may perform other operations, such as present the consumer 102 with a choice of stored payment cards, such as virtual payment card 108, to use in the course of conducting an NFC payment, may permit the consumer 102 to designate a stored payment card as a default card to be used in conducting such payments, and so on. Upon being processed by the wallet app and stored in the secure element, the virtual payment card 108 is available for use.

In operation 214, the consumer uses the app to acquire certain information concerning the good(s) or service(s) to which he or she desires to subscribe or lease-to-own, in order to create a dataset sufficient for the system 100 to form a decision as to whether to allow such goods or services to be the subject of a lease-to-own or subscription arrangement between the consumer and the company. According to some embodiments, the information acquired by the app in operation 214 includes: (1) information identifying the good(s) or service(s) to be the subject of the sought-after arrangement; (2) the price of each such good or service; and (3) the identity of the particular retailer at which the consumer is shopping. According to some embodiments, the price of each such good or service is determinable from the identifying information and identity of the retailer (this is discussed below). The data set acquired in this operation 214 forms a transaction dataset, which describes the goods or services proposed to be the subject of a lease-to-own or subscription arrangement. The transaction dataset is delivered to a decisioning service. In the context of use of the system 100 by a pre-existing user of the system 100, such a pre-existing user would have logged in (operation 203), and then begun interaction with the app at operation 214.

In operation 216, a decision process is applied to the transaction dataset. According to some embodiments, the process proceeds on an item-by-item basis, wherein each good or service within the dataset is evaluated for its propriety in terms of being the subject of a lease-to-own or subscription arrangement between the company and the consumer 102. For example, with respect to each such item, the following may be determined: (1) whether the item is of the nature that is appropriate for such arrangement (example: not consumed as a byproduct of use, amenable to return by the consumer 102, not marketed at a price less than a threshold determined by the company, and so on); and (2) whether the price, if acquired via consumer entry in operation 214, as opposed to acquired programmatically as discussed below, falls within a tolerance of an estimated price. Each item within the transaction dataset that fails to be found to be the proper subject of a lease-to-own or subscription arrangement (example: an item that fails either of the two aforementioned enumerated inquiries) is removed from the transaction dataset (operation 218). With respect to the items remaining in the transaction dataset, the aggregate spend (including tax) required to fund a purchase of such items is determined, and if the aggregate required spend is less than or equal to the consumer's 102 remaining open-to-lease line or open-to-subscribe line, then the dataset is operated upon by operation 220. On the other hand, if the aggregate required spend is greater than the consumer's 102 remaining open-to-lease line or open-to-subscribe line, then the consumer 102 may be prompted by a user interface screen to select one or more items for removal from the transaction data set, in order to bring the aggregate required spend to a value less than the aforementioned applicable remaining line, at which point the remaining transaction dataset is then operated upon by operation 220.

In operation 220, a set of interactions are engaged in with the user, resulting in the creation of an executed contract with the consumer establishing a lease-to-own or subscription arrangement for the items in the transaction dataset. For example: (1) the app my present a user interface screen that contains an estimate of the terms of the proposed arrangement; (2) the user interface estimate screen (or another screen) may present the consumer with an option to purchase companion services, along with the items in the transaction dataset (example: a damage waiver, a benefits package, and so on); (3) the app may present the user with an updated estimate of the terms of the proposed arrangement in view of the consumer's selection of any such companion services, and give the consumer 102 an opportunity to approve such terms by making an initial payment via a payment card titled in the consumer's name, i.e., not the payment card issued to the consumer 102 in the context of operation 208; (4) the app may present the consumer 102 with a user interface screen presenting an executable agreement that the consumer may read, and then sign and initial at indicated locations; and (5) the app may initiate storage of the executed agreement, such as by sending the agreement to the backend computing platform 104 or a document cloud service 106 for storage.

In the wake of execution and storage of a contract establishing the lease-to-own or subscription arrangement in operation 220, authorization criteria are established (operation 222) in order to permit the consumer 102 to initiate payment for the items that are the subject of the transaction with his payment card 108 (virtual payment card or physical payment card). According to some embodiments, the processor platform 114 is configured to decline all authorization requests originating from the payment cards 108, unless the requests meet authorization criteria. Thus, in operation 222, authorization criteria are provided to the processor platform 114, instructing it to authorize an authorization request originating from the consumer's payment card 108 only in the event that it meets conditions determined as the result of a given proposed lease-to-own or subscription arrangement having been established by means of an executed contract in operation 220. For example, assume a scenario in which the consumer 102 executed a contract to enter into a lease-to-own or subscription arrangement for items requiring an aggregate spend represented by x (denominated in dollars), from a particular retailer determined in operation 214, with execution of the aforementioned lease-to-own or subscription contract having occurred at a particular day and time. Then, in operation 222, the processor platform 114 may be provided with criteria that direct the processor 114 to approve an authorization request relating to the consumer's payment card 108, if and only if: (1) the request contains a merchant identifier (MID) corresponding to the retailer identified in operation 214; (2) the request is for a monetary amount within a particular tolerance of x (example: within 10% of x, to permit for any errors relating to estimation of tax); and (3) the request is received with a given timeframe following execution of the aforementioned contract (example: within 20 minutes of execution of the contract, to permit a reasonable period of time for the user to proceed through a queue at the retailer's various points of sale, and then ultimately initiate the payment at the point of sale 112 using the payment card 108). Together, such criteria render it particularly unlikely that a consumer 102 could use the system 100 to create a lease-to-own or subscription arrangement pertaining to certain items, only to use the payment card 108 to conduct a purchase pertaining to items that were not the subject of the arrangement.

Returning to the actions of the consumer 102, in the wake of having executed the contract (operation 220), he or she proceeds to the retailer's point of sale 112 with the items that are the subject of the just-created lease-to-own or subscription agreement in order to check out. The consumer 102 initiates payment for the items with his or her payment card 108. In the event that the consumer 102 is a new user of the system 100, then the payment card 108 will be embodied as a virtual payment card 108 stored in his mobile device 116 as described previously in connection with operation 212. If the user is a pre-existing customer, then the payment card 108 used during the checkout process will be embodied either as a physical payment card 108 or as a digital representation of such physical card 108 stored on the consumer's 102 mobile device 116 in a secure element thereon and optionally in tokenized form. In either event, in the wake of the consumer 102 having initiated the payment transaction, an authorization request will be sent to the payment network on which the card 108 is operable (via a payment processor or acquirer), and routed from the payment network to the processor platform 114, whereupon it will be received by the platform 114 (operation 224).

In operation 226, the authorization request is examined to determine which particular payment card 108 it pertains to, and the particular authorization criteria (if any) pertaining to the card is located and used to test the authorization request. If the informational content of the authorization request does not satisfy the authorization criteria (or if no such criteria are associated with the card 108), then the authorization request is declined (operation 228). On the other hand, if the authorization request does, in fact, satisfy the authorization criteria, then the authorization request is approved (operation 230), and the consumer 102 is free to leave the retailer with the items, having acquired them pursuant to a lease-to-own or subscription arrangement.

Given the foregoing authorization scheme, it may be possible that one or more items that were not included in the approved transaction dataset for inclusion in the lease-to-own or subscription arrangement were, in fact, paid for with transaction card 108. For example, consider the scenario in which a consumer 102 uses the system 100 to establish a lease-to-own or subscription arrangement vis-à-vis a television. Further consider that the consumer 102 absent-mindedly picks up a bottle of soda during his or her wait to check out. At checkout, the consumer 102 uses the card 108 to initiate purchase of both the television and the soda. If the system 100 were to establish authorization criteria using conditions similar to those described above, the authorization request would be approved (because it would be associated with the correct MID, would have been initiated within the specified timeframe, and would be for an transaction amount within the expected tolerance because a bottle of soda would not cause the aggregate transaction amount to fall outside of a reasonable tolerance as applied to a price of a television). Other possible scenarios exist wherein: (1) items in addition to those within the approved transaction dataset are purchased with the payment card 108; or (2) certain of the items within the approved transaction dataset are ultimately not part of the set of items purchased with the payment card 108. To address this possibility, the system 100 may prompt the user to provide evidence of the transaction actually conducted with the payment card 108. In the wake of having received of such evidence, the evidence is examined—either programmatically or via human intervention—to determine which particular items were actually purchased with the payment card 108. In the event that the items other than those in the approved dataset were purchased using the card 108, the system 100 may charge the cost of such items (including tax) back to the consumer 102. For example, according to some embodiments, the system 102 may store the particular payment card used by the consumer in connections with transacting his or her initial payment (see operation 220), and in the event that it becomes necessary to charge an item back to a consumer, the system 100 may use the aforementioned stored card to do so (operation 232). Finally, in operation 234, the contract establishing the lease-to-own or subscription arrangement is adjusted to: (1) reflect costs charged back to the consumer; and (2) to remove from the contract any items in the approved dataset that were not actually purchased via the payment card 108 transaction.

Certain consequences resulting from the combined structure and operation of the system 100 and method 200 are worth note. In the event that operation 216 can be performed without informational assistance by the retailer from which the items are acquired, then it is the case that a lease-to-own or subscription arrangement may be created vis-à-vis an item offered for sale by a retailer without requiring a systems integration with such retailer and without requiring any other form of pre-existing relationship between the retailer and the company offering such arrangements. For example, in many cases, an inventory of the items offered for sale by a given retailer may be acquired by virtue of crawling a retailer's e-commerce website, so that a list of every or most items offered for sale by the retailer at its brick-and-mortar locations is developed (i.e., a list of every SKU, or item name, or GTIN, etc. corresponding to the items offered for sale by the retailer is developed). The aforementioned inventory can then be structured into a whitelist (wherein the whitelist contains only those items offered for sale by the retailer that are of a nature proper for inclusion in a lease-to-own or subscription arrangement) either by human intervention via the efforts of the personnel of the lease-to-own or subscription company, or via an artificial intelligence process, or the combined efforts of both. Each item in the whitelist can then be associated with a retail price (discernible, for example by virtue of a scraping operation, from the aforementioned e-commerce site) at which the retailer offers to sell such product, and such retail price may serve as the basis for the aforementioned price tolerance band. The validation process of operation 216 can be conducted via reference to such whitelist, approving only those items that are found to be contained in the whitelist. Moreover, because payment for items is conducted via a payment card 108 in a transaction processed by the retailer's point of sale 112 pursuant to its ordinary process of barcode scanning, and so on, the need to reconcile a lease-to-own or subscription company's monthly payment to an underlying consumer transaction is eliminated.

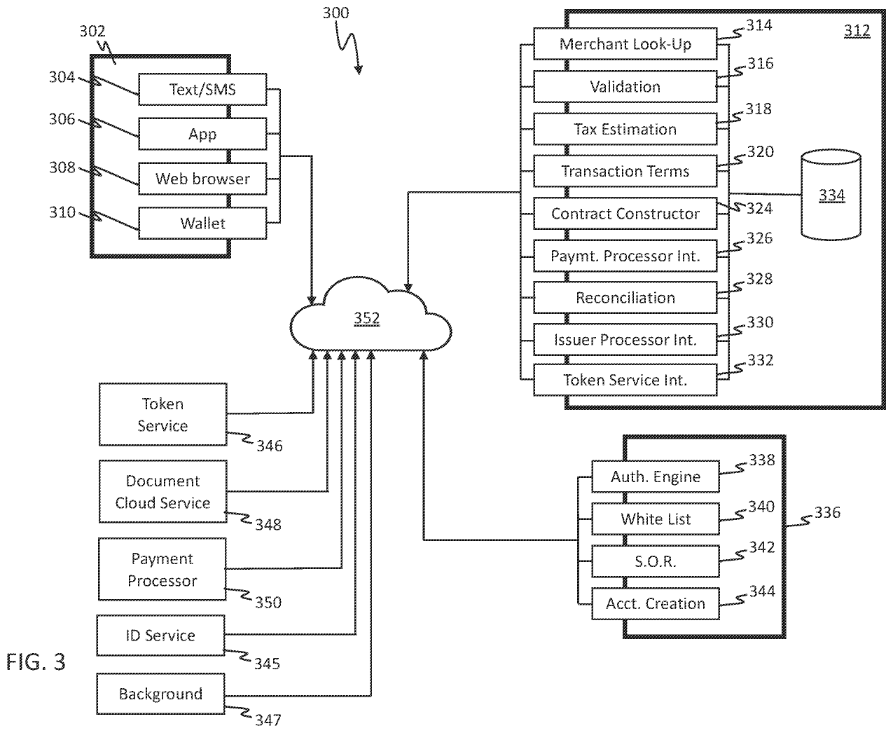

FIG. 3 depicts other embodiments of the system 100 of FIG. 1. The system 300 of FIG. 3 includes a mobile device 302, such as a smartphone, tablet, laptop, or other computing device. Installed in memory onboard the mobile device 302 are a text message or short message service (SMS) app 304, a web browser app 308, and a wallet app 310. Also installed in memory onboard the device 302 is a company app 306 published by or on behalf of the particular company offering lease-to-own or subscription arrangements. The company app 306 may be accessed by a consumer to permit the consumer to effect a lease-to-own or subscription arrangement vis-à-vis products or services offered for sale by a retailer, and to initiate a payment to such retailer in consideration of the goods or services that are the subject of such arrangement. The app 306 interacts with a backend computing platform 312, which executes services or processes 314-332 that have interfaces that are accessible to a network 352, such as the internet. The device 302 and backend computing platform 312 communicate via the aforementioned network 352. The backend computing platform 312 and app 306 also communicate and interact with various third-party services 345-350 and with an issuer processor platform 336. The issuer processor platform 336 executes services or processes 338-344 that have interfaces that are accessible to the network 352.

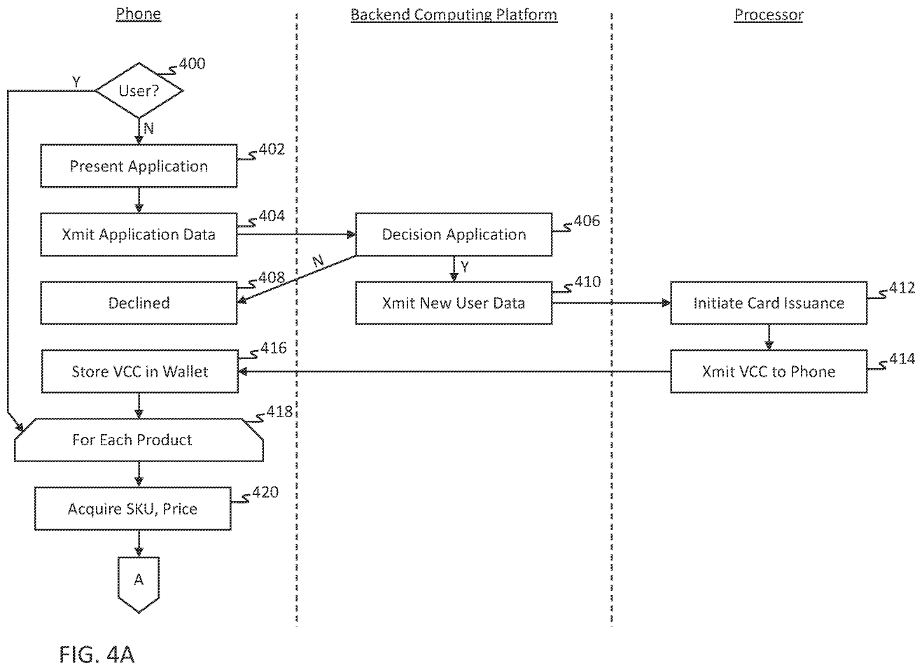

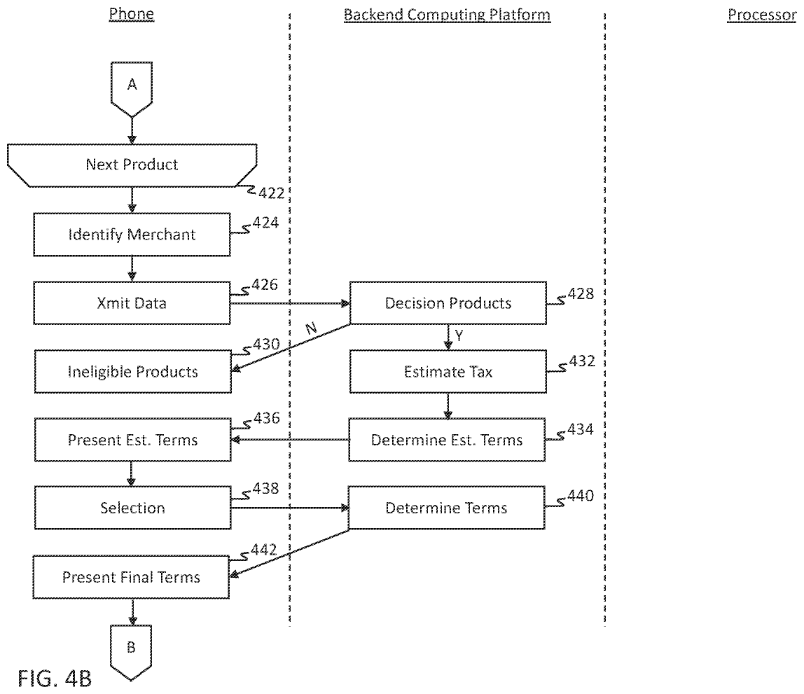

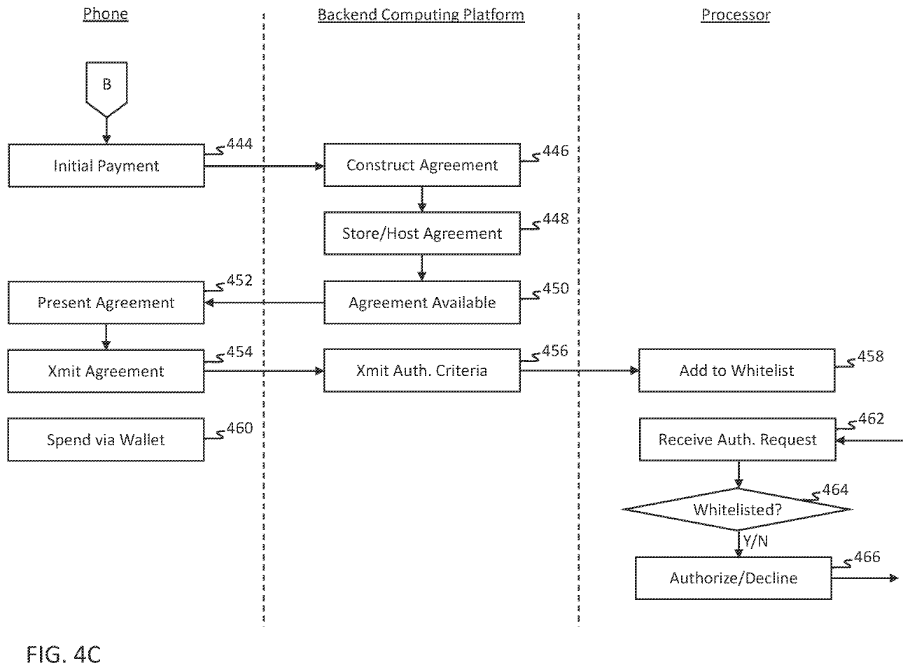

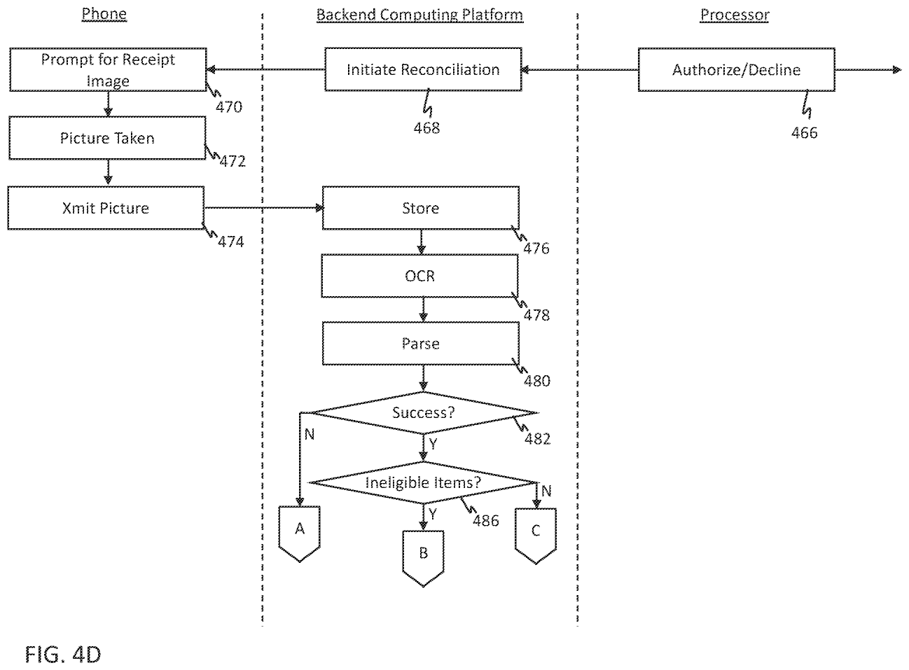

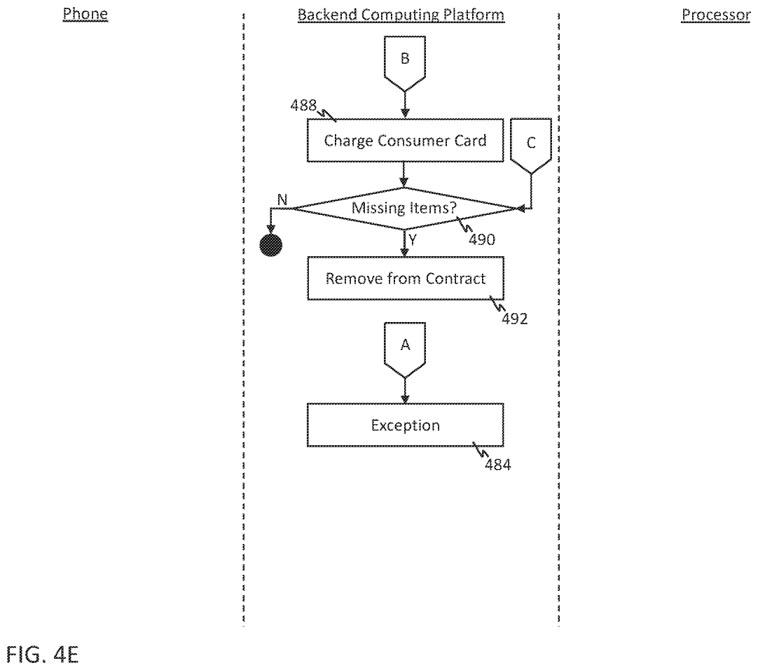

FIGS. 4A-4E depict certain embodiments of a method performed by the system 300 of FIG. 3. The circumstantial backdrop of the use of the system 300 of FIG. 3 is that a consumer is assumed to be located at a retailer and desirous of acquiring at least one good or service via a lease-to-own or subscription arrangement offered by a lease-to-own or subscription company. The consumer begins his use of the system 300 by accessing his or her mobile device 302 and launching the aforementioned company app 306. (Although discussion pertaining to FIGS. 4A-4E refer to a consumer interacting with a company app 306, according to some embodiments, all user interfaces and capabilities described as being provided by the company app 306 are provided by a website hosted by the lease-to-own or subscription company and the consumer interacts with such website via the web browser app 308). In operation 400, the app 306 presents the user with a screen asking the user to either login with his or her user credentials, or to apply as a new user of the system 300. If the user indicates that he or she does not have a pre-existing user account, then control is passed to operation 402 whereupon the user is presented with user interface screens by which he or she applies to become a customer to whom the company will extend lease-to-own or subscription arrangements. According to some embodiments, the company app 306 presents the consumer with a user interface screen prompting the consumer to enter the last four digits of his or her social security number and email address. According to some embodiments, no further application information is required from the consumer. Assuming the device 302 is a smartphone, the app 306 programmatically acquires the telephone number assigned to the device 302, otherwise the aforementioned screen prompts the consumer to enter his or her telephone number. The information collected from the consumer in operation 402 is communicated to the backend computing platform 312 (operation 404). In the context of the embodiment previously described, this means that the last four digits of the consumer's social security number, the consumer's email address and telephone number are then communicated to the backend computing platform 312.

In operation 406, the information received is operated upon by a decisioning process (operation 406). According to some embodiments, the backend computing platform 312 accesses a background check service 347 using the information provided by the user in operation 402 to acquire information about the consumer that permits a decision about whether to extend a lease-to-own or subscription arrangement to the consumer, and, if so, the size of an appropriate open-to-lease or open-to-subscribe line. According to other embodiments, the backend computing platform 312 accesses an identification service 345 to acquire a dataset of sufficient personally identifiable information required by the background service 347 for return of its results. For example, the identification service 345 may be accessed using the last-four digits of the consumer's social security, the consumer's email address and the user's telephone number (acquired in operation 402, according to some embodiments), and, on the basis of such information, the identification service 345 may return a full social security number, date of birth, street address and name for the consumer. Those informational elements may then be used to access the background service 347, which then returns information to the backend computing platform 312 sufficient for it yield a decision. In the event that a decision is made not to extend a lease-to-own or subscription arrangement to the consumer, the app presents a message declining the consumer (operation 408). On the other hand, if the consumer is approved, then the output of operation 406 is the creation of a user account for the consumer, and an open-to-lease or open-to-subscribe line for the consumer. Thereafter, information required for issuance of a payment card to the consumer is sent to the issuer processor platform 336 (operation 410), which responds by issuing a payment card to the consumer (operation 412). The payment card may be either virtual or physical—or both—as described above, and may be associated with the same variety of accounts as described above. For the sake of brevity, these matters are not described again. In the case of the virtual credit card issued to the consumer in operation 412, it is transmitted to the app in operation 414, and the wallet application 310 is accessed by the company app 306 to store the virtual card therein, as described previously (operation 416).

After storage of the card, a loop defined by loop limit indicators 418 and 422 is entered, wherein each product or service that the consumer desires to acquire via a lease-to-own or subscription arrangement is identified and associated with a price. For example, the consumer may use a camera onboard the device 302 to scan a barcode (or QR code) on the packaging of the product or service in order to acquire its shop keeper's unit (SKU) or global trade item number (GTIN) or UPC, EAN or ISBN, thereby identifying the item. The consumer may also be prompted to take a picture of a price tag associated with the item in order, and the image file resulting therefrom may be operated upon by an optical character recognition (OCR) process to extract the price information therefrom. Alternatively, according to some embodiments, the consumer may be prompted to enter the name of the product, along with its price into a user interface screen of the company app 306.

Next, in operation 424, the identity of the particular retailer at which the consumer is shopping is determined. For example, according to some embodiments, a global positioning system (GPS) receiver onboard the device is activated and the approximate geocoordinates of the consumer are determined. The geocoordinates are communicated to a merchant look-up service 314 executing on the backend computing platform 312, which returns a list of those particular merchants within a tolerance of the geocoordinates, offering goods and services that may be evaluated for suitability as subject matter of a lease-to-own or subscription arrangement. The company app 306 responds by presenting the consumer with a menu prompting the consumer to indicate at which particular retailer he or she is located, or to confirm that he or she is located at a particular retailer, in the event that there is but a single such retailer returned by the merchant look-up service 314. According to other embodiments, the consumer is prompted to enter information identifying the retailer into the app (example: street address, retailer name).

In the wake of identifying the retailer in operation 424, the identity of the particular retailer at which the consumer is located is transmitted to the backend computing platform 312 along with the item description and associated price information acquired in the loop defined by operations 418-422 (operation 426). Such information is delivered as informational input to a validation service 316 executing on the backend computing platform 312. The validation service 316 operates on an item-by-item basis, determining whether each such item is appropriate as the subject matter of a lease-to-own or subscription arrangement (operation 428). According to some embodiments, the service 316 operates in three stages: (1) it initially determines whether the item is included on a whitelist; (2) in the event that the preceding stage is satisfied, and in the further event that the associated pricing information was entered manually by the consumer, it determines whether the entered pricing information falls within a tolerance band associated with a product or service category of which the item is an element; and (3) in the event that the preceding stage is satisfied, it determines whether the consumer has a sufficient open-to-lease or subscription line to permit the arrangement to proceed. With regard to the whitelist referenced with respect to the initial stage of operation of the validation service 316, according to some embodiments, the whitelist is stored as a table or plurality of tables in a datastore 334. For example, a single table may contain a whitelist for all merchants, wherein the primary key is a composite key formed from a combination of a MID (or other identifier) determined during operation 424 and the SKU (or other product identifier) obtained during operation 420. Thus, if a record having the combined MID and SKU (or other product identifier) corresponding to a given item is present in the aforementioned table, such a record signifies the presence of the item on the whitelist. With regard to the tolerance band referenced with respect to the second stage of operation, according to some embodiments, the band is stored in the datastore 334 in association with the MID (or other identifier) and SKU (or other identifier), and is simply retrieved from the datastore 334. According to other embodiments, according to some embodiments, an e-commerce website operated by the retailer may be accessed by the backend computing platform 312, and the retail price of the item, as presented on the website may be acquired by the backend computing platform 312. The tolerance band may be determined from the retail price (example: tolerance band=retail price*[1±0.10]). If an item is found to be inappropriate for inclusion in a lease-to-own or subscription arrangement, then it is removed from the transaction dataset, i.e., the set of items to be included in the arrangement, and a message is sent from the validation service 316 to the app 306, whereupon the app notifies the consumer (operation 430). With respect to the items that are deemed to be appropriate for inclusion in a lease-to-own or subscription arrangement (because, for example, they were deemed to have met the criteria of all three aforementioned stages), a tax estimation service 318 executing on the backend computing platform 312 provides, for each such item, an estimate of the tax associated with each such item 432.

Next, in operation 434 a transaction terms service 320 executing on the backend computing platform 312 calculates, on the basis of the price of each item and the aforementioned tax estimate associated with each such item, the commercial terms of arrangement (example: a periodic cost of the arrangement, the applicable period, such as bi-weekly period or monthly period, etc., and the quantity of such periods, such as 24 bi-weekly payments). According to some embodiments, in the event that there are companion services offered for sale in association with the sought-after lease-to-own or subscription arrangement, then the commercial terms of the arrangement are estimated under the assumption that the consumer will elect to purchase such companion services. According to some embodiments, payment history of the consumer with respect to previously established arrangements with the company is taken into account in determining the commercial terms for the arrangement with the consumer. Thus, a consumer with a history of having paid in full and on time in the context of previous arrangements, will see that his or her commercial terms improve with successive arrangements.

The calculated terms of the arrangement are then communicated from the backend computing platform 312 to the app 306, whereupon they are presented via a user interface screen to the consumer (operation 436). According to some embodiments, the aforementioned user interface screen not only includes a summary of the commercial terms of the proposed arrangement, but it also includes user input elements (example: buttons) by which the consumer may indicate his intent regarding whether he or she actually wants to purchase each such companion service. The consumer indicates his or her purchase decisions vis-à-vis each such companion service via the input elements, and such input is received by the app 306 in operation 438.

After having received the consumer's various purchase decisions, the purchase decisions are communicated from the app 306 back to the transaction terms service 320 of the backend platform 312, so that the service 320 can calculate the final commercial terms of the arrangement in view of the consumer's indicated purchase decisions regarding the various companion services (operation 440). After having calculated the final commercial terms, those terms are communicated back to the app 306, and upon receipt of the final terms, the app presents them to the user in operation 442.

After having reviewed the final commercial terms of the proposed arrangement, the consumer may signify his acceptance of the terms by making an initial payment (operation 444). In operation 444, the consumer enters his or her payment information, including a payment card number from which an initial payment from the consumer to the lease-to-own or subscription company may be transaction (example: a $49 initial payment from the consumer to the company). According to some embodiments, in operation 444, the payment card information supplied by the consumer is stored (such as at the backend computing platform 312 in an encrypted database). According to some embodiments, the payment card information is communicated by either the app 306 or the backend computing platform 312 to a token service 346 that tokenizes the card number for future use (as described previously). The token may be stored either by the token service computing platform 346 or the backend computing platform 312. In addition to keeping the payment card information on file (whether tokenized or not), the information is communicated from the app 306 to a payment processor service 350 for transaction via a payment network.

In the wake of having conducted the initial payment in operation 444, a contract construction service 324 is invoked at the backend computing platform 312. Based on the information developed in the preceding operations 400-444, the contract construction service 324 creates a document, such as an editable document structured according to the portable document format (PDF), that, once executed, creates a lease-to-own or subscription agreement between the consumer and the company (operation 446). The document may be stored and hosted so that it is available to be presented by the app 306 (operation 448). For example, the document may be stored in the datastore 334 of the backend computing platform 312, or may be transmitted to a document cloud service 348 for storage and hosting, so that it might be displayed by the app 306, for example, via a web view referencing a URL referring to the document cloud service computing platform 348. After having made the document available for retrieval by the app 306 by virtue of depositing it with a hosting service (either local or third-party), the backend platform 312 communicates this fact to the app 306 (operation 450), and the app 306 responds by retrieving and presenting the document via its user interface (operation 452). While the document is presented via the user interface, the consumer reviews it, and clicks on various fields to signal or initial the document at designated locations, thereby executing the document. The executed document is then transmitted from the app 306 to either the backend computing platform 312 for storage in the datastore 334 or to the document cloud service 348 for storage there (operation 454).

In the wake of having stored the executed document, the backend computing platform 312 communicates, via an issuer processor interface 330 executing thereon, a dataset describing the anticipated payment card transaction to be initiated by the consumer at the retailer to purchase the items that are the subject of the lease-to-own or subscription arrangement (operation 456). According to some embodiments, the issuer processor computing platform 336 is structured to include an authorization engine 338 and a whitelist 340. The authorization engine 338 receives authorization requests on behalf of the issuer processor platform 336, and evaluates them to determine whether decline or authorize them. The authorization engine 338 is programmed to decline any incoming authorization unless the authorization request relates to a transaction that is included in the aforementioned whitelist 340. The whitelist 340 may be structured as a table (or plurality of tables) in a database. Upon receiving an incoming authorization request, the engine 338 extracts certain informational content from the request and formulates a query of the database therefrom to determine whether the request relates to a transaction that has been whitelisted. Examples of such criteria and informational elements have been described previously and for the sake of brevity are not repeated here. In operation 458, the dataset describing the transaction (transmitted to the issuer processor platform 336 in operation 456) is added to the whitelist 340, such as by adding a record constituted of the informational content of the dataset to the aforementioned table that may comprise the whitelist 340.

In the wake of the card transaction that is anticipated to be initiated by the consumer on behalf of the company in order to purchase the item or items that are the subject of the arrangement having been added to the whitelist 340, the consumer may proceed to check out the items and initiate payment for the items using the payment card issued by the issuer processor 336. Thus, at this point of the process, the consumer may either initiate payment using a physical payment card (if he or she was a previously existing user of the system 300 who was already in possession of the physical payment card) or may initiate payment via a virtual card stored in his or her mobile device 302 (operation 460).

In the wake of the consumer having initiated the payment, an authorization request is routed from the payment network on which the payment card is operable to the authorization engine 338 on the issuer processor computing platform 336 (operation 462). The engine 338 responds by examining the authorization request and extracting the information elements from it, and then using those elements to form a query to determine whether or not the particular payment card transaction to which the authorization request corresponds has been entered into the whitelist 340. If so, then the authorization request is approved, and such approval is returned to the payment network for return-routing to the point-of-sale system at the retailer. Additionally, the system of record 342 process executing on the issuer processor platform 336 is invoked so as to alert it of the approval, so that it properly adjusts the account relating to the payment card that the consumer used to initiate the transaction (operation 466). On the other hand, if the corresponding card transaction is not in the whitelist 340, then the authorization request is declined (operation 466), and the refusal is sent to the payment network for return-routing to the point-of-sale system at the retailer.

FIGS. 4D-4E depict an alternate embodiment in which a reconciliation is initiated by the system 400 in order to respond to scenarios in which either the set of items actually purchased with the transaction card either: (i) includes one or more items not contained in the transaction dataset; and/or (ii) fails to include one or more items contained in the transaction dataset. As shown in FIG. 4D, in the wake of approving an authorization request pertaining to a given card transaction (operation 466), the issuer processor computing platform 336 sends a message to the backend computing platform 312 identifying the particular card transaction that it has just authorized, and the platform 312 responds by initiating a reconciliation process with respect to such transaction (operation 468). The backend platform 312 sends a message to the app 306 causing it to initiate the reconciliation process vis-à-vis the card transaction.

Upon receiving the message sent to it in operation 468, the app prompts the consumer to take a picture of the receipt received by him or her during the checkout process or to attach a copy of an electronic receipt he or she received in the event the consumer elected to receive an electronic receipt, such as via email (operation 470). The consumer responds by either taking the picture or attaching the electronic receipt (operation 472), and the app 306 transmits the image file to the backend computing platform (operation 474). The platform 474 responds by storing the image file in association with the arrangement (operation 476), and then extracting the informational elements from the image file describing the items actually purchased via the card transaction (operation 478). For example, the image files may be subjected to an OCR operation to identify the various strings present in the image file. The strings may then be compared to either known structures of SKUs (or UPCs, GTINs, etc) or to known product names used by the retailer at which the transaction was conducted, in order to collect the set of strings identifying items (operation 480). The process also extracts price information associated with each such string that identifies an item. Strings contained in the image file that do not identify items or associated prices (example: strings that present the transaction date, strings that present the address of retailer, marketing strings such as “Thank you for your business,” and so on) may be discarded. Next, in operation 482, a test is applied to the output of operation 480 to determine whether the parsing process produced reliable information. For example, if in the wake of the parsing process 480 no strings were found to contain information identifying the items that were purchased, then the parsing process 480 did not produce reliable information. Alternatively, if the sum of the prices associated with the various strings descriptive of items does not fall within a tolerance of the sum of the prices acquired in operation 420 (as adjusted by the validation process 428), then then the parsing process 480 did not produce reliable information. If the test operation 482 determines that reliable information was not produced, then control passes to operation 484 wherein an exception is declared, meaning that personnel of the lease-to-own or subscription company will manually review the image, and perform the functions described with reference to operations 486-492. On the other hand, if the test 482 reveals that reliable information was produced, then control passes to operation 486.

In operation 486, the set of descriptive strings identified and collected in parsing operation 480 are tested on a one-by-one basis against the items in the transaction dataset (example: the receipt image indicates that the card transaction included a purchase of an item identified by an SKU of 186994799—does the transaction dataset include an item identified by an SKU of 186994799?; or the receipt image indicates that the card transaction included a purchase of an item identified by a product description of “Elegant brand sofa, 72 inch, brown leather”—does the transaction data set include an item identified by that string?). If the event that the card transaction is found to include payment for items that were not included in the data set, control is passed to operation 488, whereupon the consumer's payment card, which may have been stored in connection with operation 444, is charged for such item which is not part of the underlying arrangement that the card transaction was intended to fund.

In the wake of operation 488, or in the event that test operation 486 reveals that the card transaction did not include any items not contained in the transaction dataset, control is passed to operation 490. In operation 490, the set of item descriptors in the transaction data set are tested on a one-by-one basis to determine whether any are absent from the set of descriptive strings collected in parsing operation 480. Absence indicates that the consumer did not, in fact, purchase a particular item that he or she indicated would be part of the lease-to-own or subscription arrangement. If this is the case, then control is passed to operation 492, and the contract document constructed in operation 446 and ultimately stored in connection with operation 454 is edited to remove such item from the contract, and to adjust its commercial terms in view of such removal.

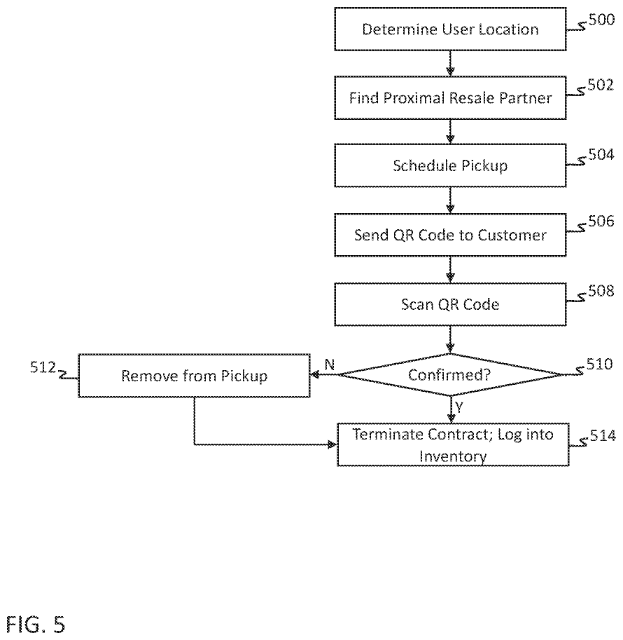

According to some embodiments, a lease-to-own arrangement or subscription arrangement may be constructed in a period-to-period fashion, so that, with the close of each period (example: a period may be a span of two weeks, a month, etc.), the consumer has an option to either: (1) make a payment in an amount set forth in the agreement document defining the arrangement (such as the agreement document created in operation 446); or (2) terminate the arrangement and return the items that are the subject of the arrangement. Thus, pursuant to these embodiments, it is possible that at any time, the consumer may desire to terminate the arrangement and return the underlying item or items. To accommodate this possibility, according to some embodiments, the system (such as system 100 or system 300) may be programmed and configured to perform the operations of FIG. 5.

According to some embodiments, the aforementioned app (such as app 306) includes a user interface screen that has a user interface element (example: a button) that permits the consumer to terminate an existing arrangement vis-à-vis a particular item or items. Thus, for example, in response to selection of the aforementioned element, the app may respond by presenting the user with a menu presenting each of the individual various items that are the subject of an arrangement between the company and the consumer. The consumer may select one or more of the presented items to indicate that he or she wishes to terminate the ongoing arrangement or arrangements vis-à-vis the selected item or items. Such selection initiates execution of the operations of FIG. 5 at operation 500.

In operation 500, the location of the items is determined. For example, the app may present the consumer with the consumer's address as reflected in the agreement (example: the agreement constructed in connection with operation 446), and prompt the consumer to either confirm that the relevant items are at the stated address, or, in the event that they are not at that address, to indicate, for each item, the address at which the item is located. According to some embodiments, a GPS system onboard the device may be used to in connection with operation 500. For example, in the event that the consumer indicates that the items are not at the address reflected on the agreement document, the user's current location may be accessed using the GPS system, and the app may ask whether the items are at the location indicated by the GPS.

In the wake of determining the location of the items, a nearby resale partner is identified (operation 502). A resale partner is a retailer that cooperates with the operator of the system 100 or 300 by reselling items that have been returned by consumers in the wake of a consumer having elected to terminate an arrangement under which he or she had acquired an item. For example, in operation 502, the particular resale partner nearest to the location identified in operation 500 may be identified. In the event that more than one location is identified in operation 500, a point of central tendency, such as a centroid, may be calculated, and the resale partner closest to such calculated point may be identified in operation 502. A scheduling system used to manage pick-up operations on behalf of the identified resale partner is accessed so as to schedule an appointment for personnel to pick up the items at the location or locations identified on the day(s) and time(s) indicated in the appointment (operation 504).

Next in operation 506, a barcode or QR code or similar sort of code that encodes information is sent to the consumer's app or otherwise made available to the app for retrieval and presentation via the user interface. The barcode or QR code either directly encodes information concerning the items to be retrieved during the aforementioned pick-up appointment, or contains a reference (example: a URL) that an app may use to acquire such information.

On the scheduled day and time of the appointment, personnel operating on behalf of the resale partner arrive at the indicated location for the appointment, and seek out the consumer to carryout out the pick-up transaction. Upon meeting the consumer, the personnel ask the consumer to display the aforementioned barcode or QR code, and the code is read using an operations app executing on a mobile device operated by one or more of the personnel. Upon reading the QR code, a list of the items to be picked up at the location is presented to the personnel, by virtue of either directly decoding such information from the barcode or QR code, or by virtue of using a reference encoded therein to access such information. The operations app then prompts its user to confirm that each of the items on the aforementioned list are available for pick-up (operation 510). In the event that one or more of the items are not available (example: an item not actually matching a particular item description within the list is presented to the personnel for pick-up), the item is removed from the aforementioned list (operation 512). Finally, in operation 514, the arrangement for each item in the aforementioned list is terminated and each item is entered into inventory of the resale partner identified in operation 502. In the event that the pick-up operation is to be performed at more than one location because more than one location was identified in operation 500, then the consumer is prompted by the company app to send the barcode or QR code, such as via text message, SMS, email or the like, to the mobile device of a person that will be present at such locations during such pick-up operations. Thus, operations 508-512 are performed at each such location.

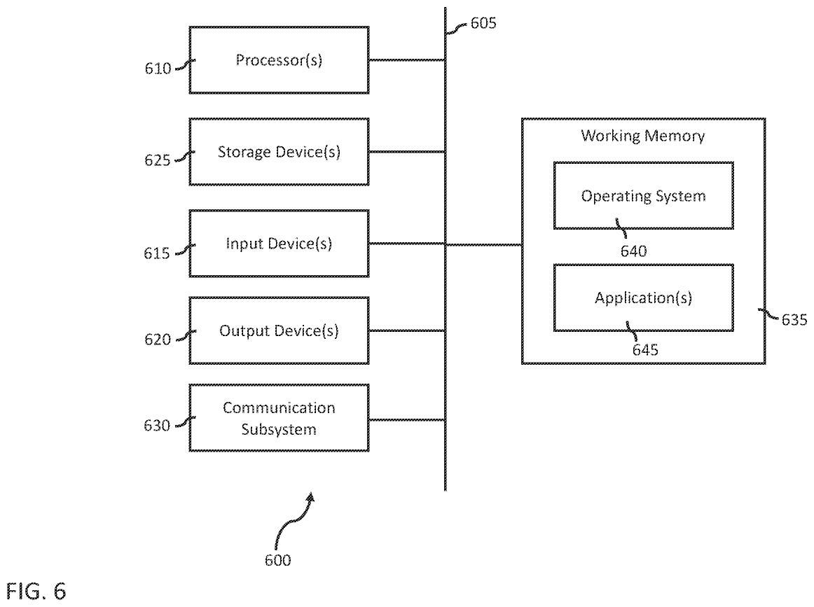

To perform the actions of the computer, laptop, tablet, smartphone, or portable device on which the app 306 or 304 executes, or of the backend platform 104 or 312, the issuer processor 312 or 104, token cloud service 346, document cloud server 348, payment processor 350, identity service 345, background investigation service 347, or third party services 106, or execute any of the methods or schemes herein and/or embody any of the other previously mentioned computing devices, a computer or server system as illustrated in FIG. 6 may be used. A networked system of such computers, devices or server systems may likewise be used. FIG. 6 depicts a schematic illustration of one embodiment of a computer system 600 that can perform the methods provided by various other embodiments, as described herein, and/or can function as the host computer system, a server system, a laptop, tablet, smartphone, a mobile device, and/or a computer system. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard, touchscreen and/or the like; and one or more output devices 620, which can include without limitation a display device, a printer and/or the like.

The computer system 600 may further include (and/or be in communication with) one or more storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 may also include a communications subsystem 630, which can include without limitation a modem, a network card (wireless or wired), an infrared communication device, a wireless communication device and/or chipset (such as a BLUETOOTH™ device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as the system 600. In other embodiments, the storage medium might be separate from a computer system (e.g., a removable medium, such as a compact disc), and or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor or processors 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to the processor or processors 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communication subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor or processors 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

The various embodiments described above are provided by way of illustration only and should not be construed to limit the invention. Those skilled in the art will readily recognize various modifications and changes that may be made to the present invention without departing from the true spirit and scope of the present invention, which is set forth in the following claims.

The claimed invention is:

1. A system for permitting a consumer to initiate payment to a retailer in consideration of an item marketed for sale by said retailer, wherein said item is a subject of a lease-to-own arrangement between said consumer and a lease-to-own company, said system comprising:
a mobile computing device accessible by said consumer, said mobile computing device including a processing unit and a memory communicably connected with and readable by the processing unit, the memory unit containing instructions that, when executed by the processing unit, cause the processing unit to:
acquire information concerning said item, and communicate said information to a remote computing platform operated by said lease-to-own company for evaluation of suitability for inclusion in a lease-to-own arrangement;
cooperate with said remote computing platform to create an agreement forming said lease to own-arrangement between said consumer and said lease-to-own company; and
permit said consumer to initiate payment for said item at said retailer via a payment card stored on a secure element onboard said mobile computing device, wherein said payment card is associated with an account, the activity of which is handled by an issuer processor computing platform that is responsive to communication from said remote computing platform in order to determine authorization criteria for authorization requests pertaining to said payment card.
